(19) United States
(12) Patent Application Publication
(10) Pub. No.: US 2024/0270048 A1
(43) Pub. Date: Aug. 15, 2024

(54) HEAT EXCHANGE SYSTEM FOR BATTERY ELECTRIC VEHICLES

(71) Applicant: TOYOTA JIDOSHA KABUSHIKI KAISHA, Aichi-ken (JP)

(72) Inventor: Eiji ISHIKAWA, Okazaki-shi (JP)

(21) Appl. No.: 18/426,337

(22) Filed: Jan. 30, 2024

(30) Foreign Application Priority Data
Feb. 10, 2023 (JP) 2023-018956

(51) Int. Cl. B60H 1/00

(52) U.S. Cl. CPC B60H 1/00871; B60H 1/00278; B60H 1/00392

(57) ABSTRACT

The heat exchange system comprises an air conditioning system, a drive source cooling system, and a duct. The duct extends from both an inside air inlet port and an outside air inlet port to an air conditioning outlet port. The duct is branched into a cooling passage and a heating passage. The evaporator is disposed upstream from a branch point of the duct. The radiator is disposed in the heating passage. A first air mix door is disposed in the cooling passage. A second air mix door is disposed downstream of the radiator in the heating passage.

### CROSS REFERENCE TO RELATED APPLICATION

This application claims priority to Japanese Patent Application No. 2023-018956, filed on Feb. 10, 2023, which is incorporated herein by reference in its entirety including the specification, claims, drawings, and abstract.

### BACKGROUND

A heat exchange system for a battery electric vehicle is disclosed herein.

In JP 2009-303465 A, a heat exchange system of a fuel cell vehicle is disclosed. The fuel cell and the radiator are connected by a refrigerant pipe. The radiator is disposed in the front region of the vehicle. When the air taken from outside of the vehicle passes through the radiator, the air and the refrigerant in the radiator exchange heat. The vehicle is provided with an air conditioning system. The air conditioning system can switch between a cooling operation and a heating operation.

Conventionally, the warm air passing through the radiator is discharged to the outside of the vehicle. Accordingly, the present specification discloses a heat exchange system for a battery electric vehicle capable of effectively utilizing heat generated from a radiator.

### SUMMARY

In this specification, a heat exchange system for a battery electric vehicle is disclosed. The system comprises an air conditioning system, a drive source cooling system, and a duct. The air conditioning system comprises an air conditioning pipe and an evaporator. The evaporator is connected to the air conditioning pipe. The drive source cooling system comprises a drive source cooling pipe and a radiator. The radiator is connected to the drive source cooling pipe. The duct extends from both an inside air inlet port and an outside air inlet port to an air conditioning outlet port. The duct is branched into a cooling passage and a heating passage. The evaporator is disposed upstream from a branch point of the duct. The radiator is disposed in the heating passage. A first air mix door is disposed in the cooling passage. A second air mix door is disposed downstream of the radiator in the heating passage.

According to the above configuration, the radiator is disposed in the heating passage for air conditioning. Thus, the heat of the radiator can be utilized for heating the air conditioning air.

In this specification, an exhaust passage may be connected to the heating passage at a position located downstream from the radiator and upstream from the second air mix door. An exhaust port is provided to a downstream end of the exhaust passage. The exhaust port is open to the outside of the battery electric vehicle.

According to the above configuration, the warm air passing through the radiator can be discharged from the exhaust port when the air conditioning system performs the cooling operation.

In this specification, an exhaust door may be disposed in the exhaust passage and configured to adjust an amount of exhaust air.

According to the above configuration, when the air conditioning system performs the heating operation, it is possible to suppress the leakage of the warm air from the radiator from the exhaust port.

In this specification, a door controller may be configured to adjust openings of the first air mix door, the second air mix door, and the exhaust door. When the air conditioning system is in a cooling operation and the drive source cooling system is in a cooling operation, the door controller outputs a close signal to an opening/closing motor for the second air mix door, and outputs an open signal to an opening/closing motor for the exhaust door.

According to the above configuration, both the cooling operation of the air conditioning system and the cooling operation of the drive source cooling system can be achieved.

According to the heat exchange system for a battery electric vehicle disclosed herein, the heat generated from the radiator can be effectively utilized.

### BRIEF DESCRIPTION OF DRAWINGS

FIG. 1 shows an example of a heat exchange system for a battery electric vehicle according to the present embodiment.

FIG. 2 illustrates the configuration of ducts and the like in the equipment compartment of the vehicle.

FIG. 3 illustrates the operation of the heat exchange system for a battery electric vehicle according to the present embodiment during heating.

FIG. 4 illustrates the operation of the heat exchange system for a battery electric vehicle according to the present embodiment at the time of cooling.

### DESCRIPTION OF EMBODIMENTS

Hereinafter, a heat exchange system for a battery electric vehicle according to the present embodiment will be described with reference to the drawings. The shapes, materials, numbers, and numerical values described below are an illustrative example. This example can be appropriately changed according to the specifications of the heat exchange system for a battery electric vehicle. In the following, the same reference numerals are given to the same elements in all the drawings.

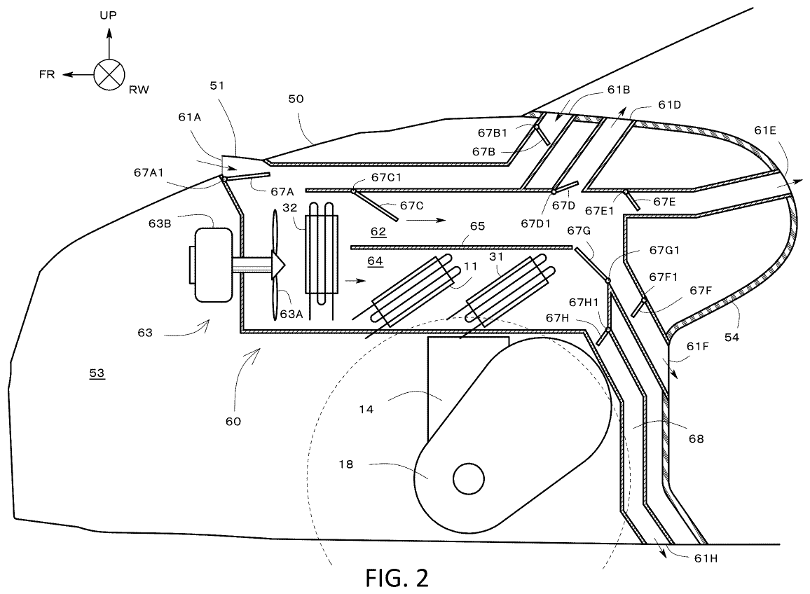

In FIG. 2 to FIG. 4, an orthogonal coordinate system including an FR axis, an RW axis, and an UP axis is used to represent the position and direction of each component. The FR axis is a vehicle longitudinal axis whose positive direction is the front of the vehicle. The RW axis is a vehicle width direction axis whose positive direction is the right side of the vehicle. The UP axis is a vertical axis of the vehicle in which the upward direction is a positive direction.

### Overall Configuration

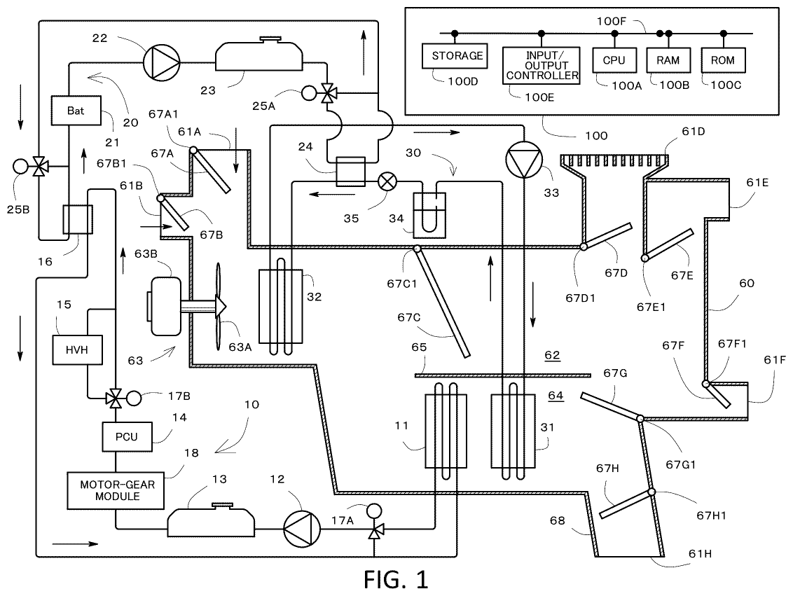

FIG. 1 shows an example of an overall diagram of a heat exchange system for a battery electric vehicle according to the present embodiment. The battery electric vehicle in which the present system is mounted includes a rotating electric machine as a drive source. For example, a motor-gear module 18 (see FIG. 2) is mounted on a vehicle. In the motor-gear module 18, a rotating electric machine and a transmission are integrated (modularized).

Conventionally, a motor-gear module 18 is mounted on an engine compartment in which an internal combustion engine is mounted. Here, in a battery electric vehicle, no internal combustion engine is mounted in a mounting chamber called an engine compartment. Therefore, instead of the term “engine compartment”, the mounting chamber is hereinafter referred to as an equipment compartment 53. The equipment compartment 53 is provided in front of the vehicle. Equipment necessary for driving the vehicle is mounted on the equipment compartment 53. As described later, the heat exchange system according to the present embodiment is mounted in the equipment compartment 53.

Referring to FIG. 1, the heat exchange system according to the present embodiment includes a drive source cooling system 10, a battery cooling system 20, and an air conditioning system 30 as a refrigerant system in which refrigerant circulates. “System” refers to a set in which individual devices are arranged to work together as parts of a mechanism. The heat exchange system also includes a duct 60 and a heat exchange controller 100.

As described later, in the heat exchange system according to the present embodiment, the radiator 11 of the drive source cooling system 10 is disposed in the duct 60. Thus, the radiator 11 can be used as a heat source for air conditioning.

The duct 60 is provided with an exhaust passage 68. When the air conditioning system 30 is in the cooling operation, the warm air passing through the radiator 11 is exhausted from the exhaust passage 68 to the outside of the vehicle. By providing the exhaust passage 68, both the cooling operation of the air conditioning system 30 and the cooling operation of the drive source cooling system 10 can be achieved.

### Drive Source Cooling System

Referring to FIG. 1, a motor-gear module 18 as a drive source and a power control unit 14 are cooled by a drive source cooling system 10. The drive source cooling system 10 includes a radiator 11, a pump 12, a reservoir tank 13, a motor-gear module 18, a power control unit 14, a heating heater 15, a heat exchanger 16, a bypass valve 17A, and a three-way valve 17B. In the drive source cooling system 10, these devices are connected by pipes (drive source cooling pipes). The drive source cooling pipe is indicated by a solid line.

The power control unit 14 includes an electronic device of a so-called high voltage system such as an inverter or a DC/DC converter. The power control unit 14 and the motor-gear module 18 may be combined as one component.

Referring to FIG. 1, a refrigerant liquid is stored in reservoir tank 13. In the heat exchanger 16, heat is exchanged between the refrigerant in the drive source cooling system 10 and the refrigerant in the battery cooling system 20. The heating heater 15 heats the refrigerant in the drive source cooling system 10.

As described later, the battery 21 has a characteristic of increasing internal resistance at low temperature. Therefore, in order to warm the battery 21, the refrigerant in the drive source cooling system 10 and the refrigerant in the battery cooling system 20 exchange heat in the heat exchanger 16. When the refrigerant of the drive source cooling system 10 is at a low temperature, the heating heater 15 is activated. The heating heater 15 heats the refrigerant.

The bypass valve 17A is provided between the radiator 11 and the pump 12. When the refrigerant is heated by the heating heater 15 as described above, the bypass valve 17A is switched. Thereby, the bypass path not passing through the radiator 11 is opened. As a result, the refrigerant during heating is prevented from being sent to the radiator 11 and dissipated.

The three-way valve 17B is provided upstream of the heating heater 15. The three-way valve 17B can switch between a plurality of paths. One of the plurality of paths is a path passing through the heating heater 15. The other one of the plurality of paths is a path through which the heating heater 15 does not pass.

When the motor-gear module 18 and the power control unit 14 are driven and generate heat, the heating heater 15 stops. For cooling of the motor-gear module 18 and the power control unit 14, the refrigerant is circulated by the pump 12.

The high temperature refrigerant passed through the motor-gear module 18 and the power control unit 14 is heat-exchanged by the radiator 11. In the heat exchange system according to the present embodiment, the radiator 11 is disposed in the duct 60. In the duct 60, the air for the air conditioning is cooled down or heated up. As described later, the heat of the radiator 11 is used for heating the air conditioning air.

### Battery Cooling System

The battery cooling system 20 includes a battery 21, a pump 22, a reservoir tank 23, a chiller 24, and three-way valves 25A and 25B. In the battery cooling system 20, these devices are connected by pipes (battery cooling pipes). The battery cooling pipe is indicated by a solid line.

The battery 21 is a power source of electric equipment including the motor-gear module 18. The battery 21 includes a battery stack in which a plurality of battery cells are stacked. The battery cell is, for example, a lithium ion battery. Lithium ion batteries have a characteristic of increasing internal resistance at low temperature. And generally, it is necessary to avoid overheating of the battery 21. Therefore, the operating temperature of the battery 21 is controlled by heating and cooling. As described above, the refrigerant in the battery cooling system 20 is heated in the heat exchanger 16. The refrigerant is cooled by the chiller 24.

The three-way valve 25A is capable of switching between a plurality of paths. One of the plurality of paths is a path through which the refrigerant passes through the chiller 24. The other one of the plurality of paths is a path through which the refrigerant avoids the chiller 24. The three-way valve 25B can also switch between a plurality of paths. One of the plurality of paths is a path through which the refrigerant passes through the heat exchanger 16. The other one of the plurality of paths is a path through which the refrigerant avoids the heat exchanger 16.

### Air Conditioning System

The air conditioning system 30 includes a condenser 31, an evaporator 32, a compressor 33, an accumulator 34, and an expansion valve 35. In the air conditioning system 30, these devices are connected by pipes (air conditioning pipes). The air conditioning pipe is indicated by a solid line.

The compressor 33 is an electric type and is supplied with electric power from, for example, the battery 21. The high-temperature and high-pressure refrigerant compressed by the compressor 33 is sent to the condenser 31. The air passing through the condenser 31 exchange heat with the refrigerant. After heat exchange, the refrigerant passes through the accumulator 34, which is an air/liquid separator. And then the refrigerant is depressurized by the expansion valve 35.

The depressurized refrigerant is sent to the chiller 24. In chiller 24, the refrigerant in battery cooling system 20 is cooled. Further, the refrigerant of the air conditioning system is sent to the evaporator 32. The air conditioned air passing through the evaporator 32 exchanges heat with the refrigerant. Thus, the air conditioning air is cooled down.

### Duct Structure

The duct 60 is a pipe through which air flows. The duct 60 extends from both the outside air inlet port 61A and the inside air inlet port 61B to the air conditioning outlet port. As the air conditioning outlet port, the duct 60 includes a front defroster duct 61D, a face register 61E, and a foot register 61F.

The interior of the duct 60 is branched into a cooling passage 62 and a heating passage 64. The cooling passage 62 and the heating passage 64 are separated each other by a partition wall 65 provided in the duct 60. In the duct 60, the evaporator 32 is disposed on the upstream region of the branch point between the cooling passage 62 and the heating passage 64.

Further, a blower 63 is disposed upstream of the evaporator 32. The blower 63 includes a blower fan 63A and a blower motor 63B. When the blower fan 63A is driven to rotate, outside air and inside air are sent to the evaporator 32.

A condenser 31 and a radiator 11 are disposed in the heating passage 64. The condenser 31 and the radiator 11 are both heat exchangers. The condenser 31 exchanges heat between the high temperature refrigerant flowing through the air conditioning system 30 and the air for the air conditioning. In the radiator 11, high-temperature refrigerant passed through the drive source cooling system 10 exchanges heat with the air for the air-conditioning.

The arrangement order of the radiator 11 and the condenser 31 is determined according to the temperature of the refrigerant flowing into the radiator 11 and the condenser 31. For example, the operating temperature of the power control unit 14 incorporating an inverter or the like is set to 50° C. or lower. On the other hand, the temperature of the refrigerant compressed in the compressor 33 is increased to about 80° C.

That is, the refrigerant flowing into the radiator 11 has a lower temperature than the refrigerant flowing into the condenser 31. Even if the air passing through the radiator 11 is heated to 50° C., sufficient cooling effect can be obtained for the refrigerant flowing at 80° C. Therefore, in the duct 60, the radiator 11 is disposed on the upstream side, and the condenser 31 is disposed on the downstream side.

The refrigerant temperature flowing into the condenser 31 may be equal to or lower than the refrigerant temperature flowing into the radiator 11. In this case, the condenser 31 is disposed on the upstream side, and the radiator 11 is disposed on the downstream side.

The duct 60 includes an exhaust passage 68. An exhaust passage 68 is connected to the heating passage 64 on the downstream side of the radiator 11 and on the upstream side of the second air mix door 67G. For example, the exhaust passage 68 is connected to the heating passage 64 from the downstream side of the condenser 31. An exhaust port 61H is provided at a downstream end of the exhaust passage 68. The exhaust port 61H is opened to the outside of the vehicle. As described later, when the air conditioning system is in the cooling operation and the drive source cooling system 10 is in the cooling operation, the air heated through the radiator 11 is exhausted from the exhaust passage 68 to the outside of the vehicle.

The duct 60 includes a door for adjusting the opening at the inlet port and the outlet port. An outside air door 67A is provided in the outside air inlet port 61A. An inside air door 67B is provided at the inside air inlet port 61B. A defroster door 67D is provided in the front defroster duct 61D. The face register 61E is provided with a face door 67E. The foot register 61F is provided with a foot door 67F.

An air mix door for adjusting the mixing amount of the cold air and the warm air is provided inside the duct 60. For example, a first air mix door 67C is provided upstream of the cooling passage 62. A second air mix door 67G is provided downstream of the radiator 11. For example, a second air mix door 67G is provided at a junction of the heating passage 64 and the cooling passage 62.

The first air mix door 67C adjusts the amount of air flowing into the cooling passage 62. The air amount of the air heated through the radiator 11 and the condenser 31 to the air conditioning outlet is adjusted by the second air mix door 67G.

Further, an exhaust door 67H is provided at the exhaust port 61H. The exhaust door 67H adjusts the amount of air (exhaust amount) supplied from the heating passage 64 to the exhaust passage 68.

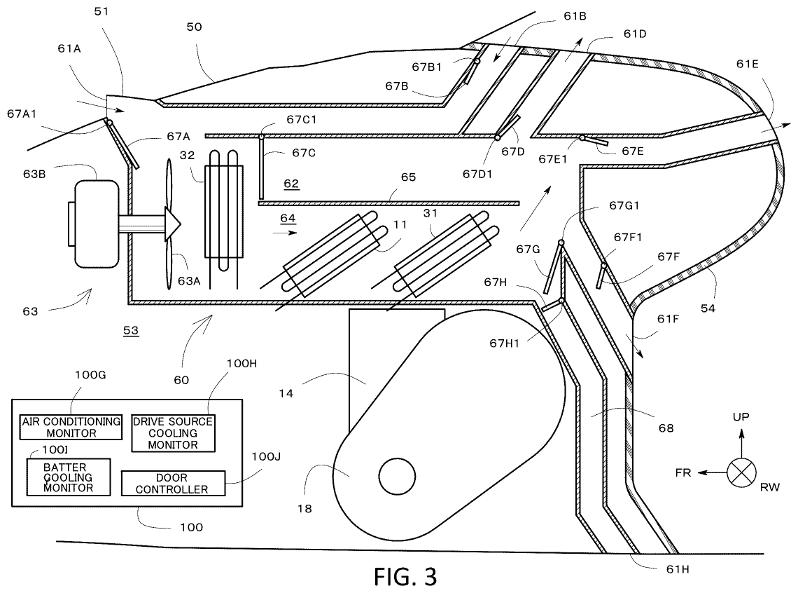

The outside air door 67A, the inside air door 67B, the first air mix door 67C, the defroster door 67D, the face door 67E, the foot door 67F, the second air mix door 67G, and the exhaust door 67H are opened and closed by an opening/closing motor 67A1, 67B1, 67C1, 67D1, 67E1, 67F1, 67G1, 67H1. These opening/closing motors are controlled by a door controller 100J (see FIG. 3) of the heat exchange controller 100 (see FIG. 3).

### In-Vehicle Placement of Ducts

FIG. 2 shows an example of the arrangement of the duct 60 in the equipment compartment 53. The duct 60 is disposed above the motor-gear module 18. The motor-gear module 18, which is a drive source, is smaller than, for example, an internal combustion engine which is a conventional drive source. And the space occupied by the internal combustion engine is utilized for the installation space of the motor-gear module 18 (and the power control unit 14) and the duct 60.

The duct 60 is disposed in a region from the middle to the rear of the equipment compartment 53 along the longitudinal direction of the vehicle. The outside air inlet port 61A, which is an inlet of the duct 60, is provided on the hood duct 51. The hood duct 51 is provided at an intermediate position of the hood 50 provided in front of the vehicle in the longitudinal direction of the vehicle.

The instrument panel 54 is provided with the inside air inlet port 61B, a front defroster duct 61D, a face register 61E, and a foot register 61F. Further, the exhaust port 61H is provided in front of the instrument panel 54. The exhaust port 61H is opened at the floor of the vehicle toward the road surface.

For example, duct 60 extends linearly over motor-gear module 18. In addition, the condenser 31 and the radiator 11 are disposed in an inclined position according to the tube diameter of the heating passage 64. As described above, in the heat exchange system according to the present embodiment the radiator 11 disposed on the front surface of the vehicle is disposed in the middle of the equipment compartment 53 along the longitudinal direction of the vehicle. Thereby, the front portion of the equipment compartment 53 becomes a vacant space. In this free space, for example, a trunk room (flank room) is formed.

### Heat Exchange Controller

Referring to FIG. 3, heat exchange controller 100 is disposed, for example, in equipment compartment 53. Referring to FIG. 1, heat exchange controller 100 includes, for example, a computer. The heat exchange controller 100 includes a CPU 100A as a calculation device and a control device. The heat exchange controller 100 includes a RAM 100B, a ROM 100C, and a storage 100D as storage devices. The heat exchange controller 100 further includes an input/output controller 100E as an interface device with peripheral devices. These devices are connected by an internal bus 100F.

For example, when the CPU 100A executes a control program stored in the storage 100D, a function-specific module as illustrated in FIG. 3 is constructed in the heat exchange controller 100. That is, the heat exchange controller 100 includes an air conditioning monitor 100G, a drive source cooling monitor 100H, a battery cooling monitor 100I, and a door controller 100J.

The air conditioning monitor 100G monitors the operation of the air conditioning system 30 (see FIG. 1) and the blower 63. The air conditioning monitor 100G monitors whether the air conditioning system 30 is operating or stopping. For example, the air conditioning monitor 100G confirms the operation of the compressor 33. Further, when the air conditioning system 30 is operating, the air conditioning monitor 100G monitors whether the air conditioning system 30 is in the cooling operation or the heating operation. For example, operation information of an air conditioning operation panel (not shown) provided in the instrument panel 54 is transmitted to the air conditioning monitor 100G.

The drive source cooling monitor 100H monitors the operation of the drive source cooling system 10. The drive source cooling monitor 100H monitors whether the drive source cooling system 10 is operating or stopping. For example, the drive source cooling monitor 100H confirms the operating state of the pump 12. Further, when the drive source cooling system 10 is operating, the drive source cooling monitor 100H monitors whether the drive source cooling system 10 is in the cooling operation or the warming operation. For example, the open/closed state of the bypass valve 17A and the three-way valve 17B and the on/off information of the heating heater 15 are transmitted to the drive source cooling monitor 100H.

The battery cooling monitor 100I monitors the operation of the battery cooling system 20. The battery cooling monitor 100I monitors whether the battery cooling system 20 is operating or stopping. For example, the battery cooling monitor 100I confirms the operation of the pump 22. Further, when the battery cooling system 20 is in operation, the battery cooling monitor 100I monitors whether the battery cooling system 20 is in the cooling operation or the warming operation. For example, the open/closed states of the three-way valves 25A and 25B are transmitted to the battery cooling monitor 100I.

The door controller 100J adjusts opening of various doors provided inside the duct 60. Specifically, the opening of the outside air door 67A, the inside air door 67B, the first air mix door 67C, the defroster door 67D, the face door 67E, the foot door 67F, the second air mix door 67G, and the exhaust door 67H are adjusted by the door controller 100J. In this adjustment, the door controller 100J transmits an opening signal to the opening/closing motor 67A1, 67B1, 67C1, 67D1, 67E1, 67F1, 67G1, 67H1. The opening signal includes a closing signal (full closing), an opening signal (full opening), and a signal instructing an opening between them.

### Operation During Heating

FIG. 3 illustrates the operation of the heat exchange system during heating. In FIG. 3, the air conditioning system 30 (see FIG. 1) is in the heating operation, the battery cooling system 20 is in the cooling operation, and the drive source cooling system 10 is also in the cooling operation.

The door controller 100J acquires the operating states of the respective systems from the air conditioning monitor 100G, the drive source cooling monitor 100H, and the battery cooling monitor 100I. When the air conditioning monitor 100G is in the heating operation and the drive source cooling monitor 100H is in the cooling operation, the door controller 100J outputs a closing signal to the opening/closing motor 67C1 of the first air mix door 67C. Thereby, the cooling passage 62 is closed. As a result, the total amount of air-conditioned air taken from the outside air inlet port 61A and the inside air inlet port 61B is sent to the heating passage 64.

Further, the door controller 100J outputs an opening signal to the opening/closing motor 67G1 of the second air mix door 67G. Further, the door controller 100J outputs a closing signal to the opening/closing motor 67H1 of the exhaust door 67H. Thereby, the whole amount of the air conditioned air heated by passing through the heating passage 64 is sent to the air conditioning outlet of the face register 61E or the like.

Here, when the drive source cooling system 10 is in the cooling operation, the door controller 100J performs complementary opening and closing control of the second air mix door 67G and the exhaust door 67H. That is, when one of the second air mix door 67G and the exhaust door 67H is closed, the door controller 100J opens the another one. Such complementary opening and closing ensures heat exchange of the radiator 11.

### Operation During Cooling

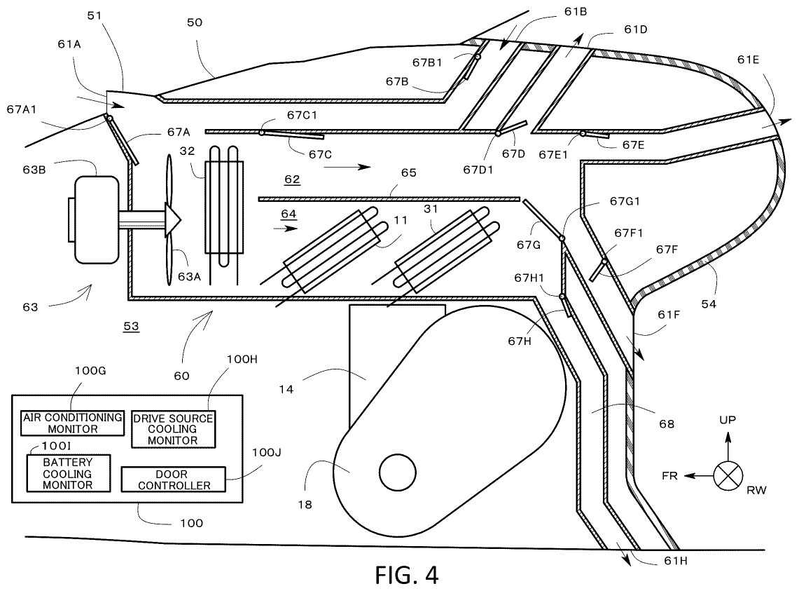

FIG. 4 illustrates the operation of the heat exchange system during cooling. In this example, the air conditioning system 30 (see FIG. 1) is in the cooling operation, the battery cooling system 20 is in the cooling operation, and the drive source cooling system 10 is also in the cooling operation.

The door controller 100J acquires the operating states of the respective systems from the air conditioning monitor 100G, the drive source cooling monitor 100H, and the battery cooling monitor 100I. When the air conditioning monitor 100G is in the cooling operation and the drive source cooling monitor 100H is in the cooling operation, the door controller 100J outputs an opening signal to the opening/closing motor 67C1 of the first air mix door 67C. Thus, the air conditioned air taken from the outside air inlet port 61A and the inside air inlet port 61B is divided into the cooling passage 62 and the heating passage 64.

Further, the door controller 100J outputs a closing signal to the opening/closing motor 67G1 of the second air mix door 67G. Further, the door controller 100J outputs an opening signal to the opening/closing motor 67H1 of the exhaust door 67H. Thus, the air after heat exchange with the condenser 31 and the radiator 11 is prevented from leaking to the air conditioning outlet. The air is discharged from the exhaust port 61H to the outside of the vehicle.

The present disclosure is not limited to the present embodiments described above, and includes all changes and modifications without departing from the technical scope or the essence of the present disclosure defined by the claims.

1. A heat exchange system for a battery electric vehicle, comprising:
an air conditioning system comprising an air conditioning pipe and an evaporator, the evaporator being connected to the air conditioning pipe;
a drive source cooling system comprising a drive source cooling pipe and a radiator, the radiator being connected to the drive source cooling pipe; and
a duct extending from both an inside air inlet port and an outside air inlet port to an air conditioning outlet port, the duct being branched into a cooling passage and a heating passage; wherein
the evaporator is disposed upstream from a branch point of the duct;
the radiator is disposed in the heating passage;
a first air mix door is disposed in the cooling passage; and
a second air mix door is disposed downstream of the radiator in the heating passage.

2. The heat exchange system for a battery electric vehicle according to claim 1, wherein
an exhaust passage is connected to the heating passage at a position located downstream from the radiator and upstream from the second air mix door;
an exhaust port is provided to a downstream end of the exhaust passage; and
the exhaust port is open to the outside of the battery electric vehicle.

3. The heat exchange system for an battery electric vehicle according to claim 2, further comprising an exhaust door disposed in the exhaust passage and configured to adjust an amount of exhaust air.

4. The heat exchange system for a battery electric vehicle according to claim 3, further comprising:
a door controller configured to adjust openings of the first air mix door, the second air mix door, and the exhaust door; wherein
when the air conditioning system is in a cooling operation and the drive source cooling system is in a cooling operation, the door controller outputs a close signal to an opening/closing motor for the second air mix door, and outputs an open signal to an opening/closing motor for the exhaust door.
